(19) United States
(12) Patent Application Publication
(10) Pub. No.: US 2026/0088346 A1
(43) Pub. Date: Mar. 26, 2026

(54) SOLID ELECTROLYTE MATERIAL AND BATTERY USING THE SAME

(71) Applicant: Panasonic Intellectual Property Management Co., Ltd., Osaka (JP)

(72) Inventors: MASASHI SAKAIDA, Hyogo (JP); KOKI UENO, Osaka (JP)

(21) Appl. No.: 19/407,927

(22) Filed: Dec. 3, 2025

Related U.S. Application Data
(63) Continuation of application No. PCT/JP2024/015011, filed on Apr. 15, 2024.

(30) Foreign Application Priority Data
Jun. 20, 2023 (JP) 2023-101207

(51) Int. Cl. H01M 10/0562; H01M 10/0525

(52) U.S. Cl. CPC H01M 10/0562; H01M 10/0525; H01M 2300/008

(57) ABSTRACT

A solid electrolyte material contains Li, Sn, M1, and F, where M1 is at least one selected from the group consisting of Al, Y, Zr, Ti, and Mg. A battery includes: a positive electrode; a negative electrode; and a separator layer between the positive electrode and the negative electrode. At least one selected from the group consisting of the positive electrode, the negative electrode, and the separator layer contains the solid electrolyte material.

### BACKGROUND

### 1. Technical Field

The present disclosure relates to a solid electrolyte material and a battery using the solid electrolyte material.

### 2. Description of the Related Art

Fluoride solid electrolyte materials generally have high oxidation resistance. Japanese Unexamined Patent Application Publication No. 2008-277170 discloses LiBF₄ as a fluoride solid electrolyte material.

### SUMMARY

One non-limiting and exemplary embodiment provides a fluoride solid electrolyte material with an improved lithium ion conductivity.

In one general aspect, the techniques disclosed here feature a solid electrolyte material containing Li, Sn, M1, and F, wherein M1 is at least one selected from the group consisting of Al, Y, Zr, Ti, and Mg.

The present disclosure provides a fluoride solid electrolyte material with an improved lithium ion conductivity.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view of a battery 1000 as a first example of a battery according to a second embodiment;

FIG. 2 is a cross-sectional view of a battery 2000 as a second example of the battery according to the second embodiment;

FIG. 3 is a cross-sectional view of a battery 3000 as a third example of the battery according to the second embodiment;

FIG. 4 is a schematic view of a press forming die 500 used to evaluate the ionic conductivity of a solid electrolyte material;

FIG. 5 is a graph of a Cole-Cole plot obtained by impedance measurement of a solid electrolyte material according to Example 1; and

FIG. 6 is a graph of the initial discharge characteristics of a battery according to Example 1.

### DETAILED DESCRIPTIONS

Embodiments of the present disclosure will be described with reference to the accompanying drawings.

### First Embodiment

A solid electrolyte material according to a first embodiment contains Li, Sn, M1, and F. M1 is at least one selected from the group consisting of Al, Y, Zr, Ti, and Mg.

With the above configuration, the solid electrolyte material according to the first embodiment has an improved lithium ion conductivity.

The solid electrolyte material according to the first embodiment is a fluoride solid electrolyte material containing F. Thus, the solid electrolyte material according to the first embodiment can have high oxidation resistance. This is because F has a high redox potential. On the other hand, F has a high electronegativity and therefore forms a relatively strong bond with Li. Consequently, a fluoride solid electrolyte material generally tends to have a low lithium ion conductivity. For example, LiBF₄ disclosed in Japanese Unexamined Patent Application Publication No. 2008-277170 has a low ionic conductivity of 6.67× 10⁻⁹ S/cm.

The solid electrolyte material according to the first embodiment can improve the lithium ion conductivity of a fluoride solid electrolyte material. The solid electrolyte material according to the first embodiment can have, for example, a practical lithium ion conductivity and can have, for example, a high lithium ion conductivity. In the present description, the high lithium ion conductivity is, for example, 8×10⁻⁹ S/cm or more at approximately room temperature (for example, 25° C.). The solid electrolyte material according to the first embodiment may have an ionic conductivity of, for example, 8×10⁻⁹ S/cm or more.

The solid electrolyte material according to the first embodiment desirably contains substantially no sulfur. The phrase “the solid electrolyte material according to the first embodiment contains substantially no sulfur” means that the solid electrolyte material does not contain sulfur as a constituent element except for sulfur inevitably mixed as an impurity. In this case, sulfur mixed into the solid electrolyte material as an impurity is, for example, 1% or less by mole. It is more desirable that the solid electrolyte material according to the first embodiment does not contain sulfur. A solid electrolyte material that does not contain sulfur does not generate hydrogen sulfide even when exposed to the atmosphere, and therefore has good safety.

To increase the lithium ion conductivity of a solid electrolyte material, the solid electrolyte material according to the first embodiment may further contain an anion other than F. Examples of the anion include Cl, Br, I, O, S, and Se.

The solid electrolyte material according to the first embodiment may consist essentially of Li, Sn, M1, and F. The phrase “the solid electrolyte material according to the first embodiment consists essentially of Li, Sn, M1, and F” means that the molar ratio of the total amount of substance of Li, Sn, M1, and F to the total amount of substance of all elements constituting the solid electrolyte material according to the first embodiment is 90% or more. As an example, the molar ratio may be 95% or more. The solid electrolyte material according to the first embodiment may composed only of Li, Sn, M1, and F.

The solid electrolyte material according to the first embodiment may contain an inevitably mixed element. Examples of the element include hydrogen, oxygen, and nitrogen. Such an element may be present in a raw powder material of a solid electrolyte material or in an atmosphere for producing or storing a solid electrolyte material. In the solid electrolyte material according to the first embodiment, the inevitably mixed element as described above constitutes, for example, 1% or less by mole.

To increase the lithium ion conductivity of a solid electrolyte material, in the solid electrolyte material according to the first embodiment, M1 may contain at least one selected from the group consisting of Al and Y.

To further increase the lithium ion conductivity of a solid electrolyte material, the ratio of the amount of substance of Li to the total amount of substance of cation other than Li may be greater than or equal to 1.7 and may be less than or equal to 4.2.

The solid electrolyte material according to the first embodiment may be represented by the following formula (1-1):

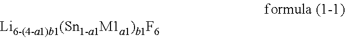

wherein a1 and b1 satisfy the relations 0<a1<1 and 0<b1≤1.5. In the formula (1-1), M1 is at least one selected from the group consisting of Al and Y, which are trivalent cations.

When the solid electrolyte material according to the first embodiment is represented by the formula (1-1), the solid electrolyte material according to the first embodiment can further improve the ionic conductivity.

To increase the ionic conductivity of the solid electrolyte material, the solid electrolyte material according to the first embodiment may have a crystalline phase represented by the formula (1-1).

The solid electrolyte material according to the first embodiment may further contain oxygen (O). In this case, the solid electrolyte material according to the first embodiment may be represented by the following formula (1-2):

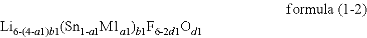

wherein a1, b1, and M1 in the formula (1-2) are the same as a1, b1, and M1 in the formula (1-1), respectively. In the formula (1-2), d1 satisfies the relation 0<d1<3.

When the solid electrolyte material according to the first embodiment is represented by the formula (1-2), the solid electrolyte material according to the first embodiment can further improve the ionic conductivity as in the case where the solid electrolyte material is represented by the formula (1-1).

To increase the ionic conductivity of the solid electrolyte material, the solid electrolyte material according to the first embodiment may have a crystalline phase represented by the formula (1-2).

To increase the ionic conductivity of the solid electrolyte material, in the compositional formulae (1-1) and (1-2), a1 may satisfy the relation 0.01≤a1≤0.99.

To increase the ionic conductivity of the solid electrolyte material, in the compositional formulae (1-1) and (1-2), a1 may satisfy the relation 0.01≤a1≤0.7.

To increase the ionic conductivity of the solid electrolyte material, in the compositional formulae (1-1) and (1-2), b1 may satisfy the relation 0.8≤b1≤1.2.

To increase the ionic conductivity of the solid electrolyte material, in the compositional formulae (1-1) and (1-2), M1 may be Al. For example, in the compositional formulae (1-1) and (1-2), M1 may be Al, and a1 may satisfy the relation 0.01≤a1≤0.99. With this configuration, the solid electrolyte material according to the first embodiment can further increase the ionic conductivity. To further increase the ionic conductivity of the solid electrolyte material, in the compositional formulae (1-1) and (1-2), M1 may be Al, and a1 may satisfy the relation 0.01≤a1≤0.7.

To increase the ionic conductivity of the solid electrolyte material, the solid electrolyte material according to the first embodiment may contain Li, Sn, Al, M2, and F. M2 is at least one selected from the group consisting of Y, Zr, Ti, and Mg.

The solid electrolyte material according to the first embodiment may be represented by the following formula (2-1):

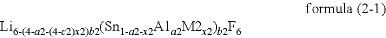

wherein a2, x2, and b2 satisfy the relations 0<a2<1, 0<x2<1, 0<a2+x2<1, and 0<b2≤1.5. c2 is the valence of M2.

To increase the ionic conductivity of the solid electrolyte material, the solid electrolyte material according to the first embodiment may have a crystalline phase represented by the formula (2-1).

The solid electrolyte material according to the first embodiment may contain oxygen (O) as described above, and in this case, the solid electrolyte material according to the first embodiment may be represented by the following formula (2-2):

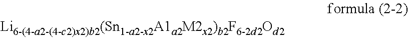

wherein a2, b2, c2, and M2 in the formula (2-2) are the same as a2, b2, c2, and M2 in the formula (2-1), respectively. In the formula (2-2), d2 satisfies the relation 0<d2<3.

To increase the ionic conductivity of the solid electrolyte material, the solid electrolyte material according to the first embodiment may have a crystalline phase represented by the formula (2-2).

An effective means for improving the lithium ion conductivity is, for example, the introduction of strain into a crystal structure by forming a solid solution of different cations. Ti and Zr have the same valence of 4 as Sn, Y has the same valence of 3 as Al, and Mg has an ionic radius close to that of Sn. Thus, in a solid electrolyte material containing Li, Sn, Al, and F, Y, Zr, Ti, and Mg are each relatively easily solid-dissolved, and improvement in lithium ion conductivity can be expected. A solid electrolyte material having such a crystalline phase has a high ionic conductivity.

To increase the ionic conductivity of the solid electrolyte material, in the compositional formulae (2-1) and (2-2), a2 may satisfy the relation 0.01≤a2≤0.99.

To increase the ionic conductivity of the solid electrolyte material, in the compositional formulae (2-1) and (2-2), a2 may satisfy the relation 0.01≤a2≤0.7.

To increase the ionic conductivity of the solid electrolyte material, in the compositional formulae (2-1) and (2-2), b2 may satisfy the relation 0.8≤b2≤1.2.

The solid electrolyte material according to the first embodiment may be crystalline or amorphous.

The solid electrolyte material according to the first embodiment may have any shape. Examples of the shape include needle-like, spherical, and ellipsoidal. The solid electrolyte material according to the first embodiment may be particles. The solid electrolyte material according to the first embodiment may be formed to have a shape of a pellet or a plate.

When the shape of the solid electrolyte material according to the first embodiment is, for example, particulate (for example, spherical), the solid electrolyte material may have a median size of greater than or equal to 0.1 μm and less than or equal to 100 μm. The median size refers to the particle size at which the cumulative volume in the volumetric particle size distribution reaches 50%. The volumetric particle size distribution is measured, for example, with a laser diffraction measuring apparatus or an image analyzer.

The solid electrolyte material according to the first embodiment may have a median size of greater than or equal to 0.5 μm and less than or equal to 10 μm. This allows the solid electrolyte material to have a higher ionic conductivity. This also improves the dispersion state of the solid electrolyte material according to the first embodiment and another material, such as an active material.

### Method for Producing Solid Electrolyte Material

The solid electrolyte material according to the first embodiment can be produced, for example, by the following method.

For example, raw powder materials of a plurality of halides are mixed to have a target composition.

For example, when the target composition is Li_{2.7}Sn_{0.3}Al_{0.7}F₆, LiF, SnF₄, and AlF₃ may be mixed at a molar ratio of approximately 2.7:0.3:0.7. The raw powder materials may be mixed at a molar ratio adjusted in advance so as to offset a composition change that may occur in a synthesis process.

The raw powder materials are reacted with each other mechanochemically (that is, using a mechanochemical milling method) in a mixing apparatus, such as a planetary ball mill, to produce a reaction product. The reaction product may be heat-treated in a vacuum or in an inert atmosphere. Alternatively, the mixture of the raw powder materials may be heat-treated in a vacuum or in an inert atmosphere to produce a reaction product. The heat treatment is preferably performed, for example, at 100° C. or more and 300° C. or less for 1 hour or more. To suppress a composition change during heat treatment, the raw powder materials are preferably heat-treated in an airtight container, such as a quartz tube.

The solid electrolyte material according to the first embodiment is produced by such a method.

The composition of a solid electrolyte material can be determined, for example, by ICP spectroscopy, ion chromatography, an inert gas fusion-infrared absorption method, or an electron probe micro analyzer (EPMA) method. For example, the composition of Li, Sn, and M1 can be determined by ICP spectroscopy, and the composition of F can be determined by ion chromatography.

### Second Embodiment

A second embodiment will be described below. The items described in the first embodiment will be omitted as appropriate.

A battery according to the second embodiment includes a positive electrode, a negative electrode, and a separator layer. The separator layer is provided between the positive electrode and the negative electrode.

At least one selected from the group consisting of the positive electrode, the negative electrode, and the separator layer contains the solid electrolyte material according to the first embodiment.

The battery according to the second embodiment contains the solid electrolyte material according to the first embodiment and therefore has good charge-discharge characteristics.

The battery according to the second embodiment may be an all-solid-state battery using a solid electrolyte as an electrolyte or may be a liquid battery using an electrolyte solution as an electrolyte. The all-solid-state battery may be a primary battery or a secondary battery.

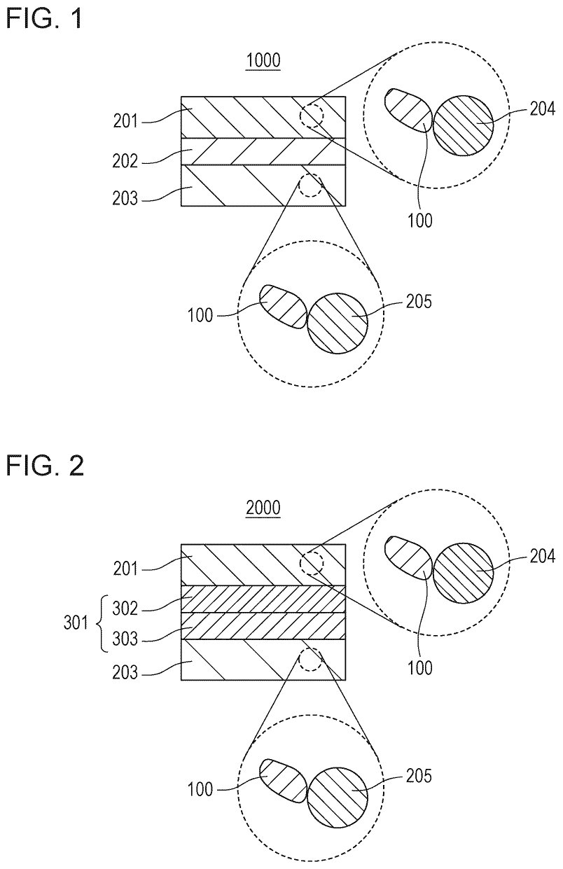

FIG. 1 is a cross-sectional view of a battery 1000 as a first example of the battery according to the second embodiment. The battery 1000 of the first example is a configuration example in which the separator layer is an electrolyte layer formed of an electrolyte material. In the battery 1000, the electrolyte layer is, for example, a solid electrolyte layer, that is, the battery 1000 is, for example, an all-solid-state battery.

The battery 1000 of the first example includes a positive electrode 201, an electrolyte layer 202, and a negative electrode 203. The electrolyte layer 202 is provided between the positive electrode 201 and the negative electrode 203.

The positive electrode 201 contains a positive-electrode active material 204 and a solid electrolyte 100.

The electrolyte layer 202 contains an electrolyte material.

The negative electrode 203 contains a negative-electrode active material 205 and the solid electrolyte 100.

The solid electrolyte 100 contains, for example, the solid electrolyte material according to the first embodiment. The solid electrolyte 100 may be particles containing the solid electrolyte material according to the first embodiment as a main component. The particles containing the solid electrolyte material according to the first embodiment as a main component refer to particles in which the component contained in the largest amount in terms of molar ratio is the solid electrolyte material according to the first embodiment. The solid electrolyte 100 may be particles formed of the solid electrolyte material according to the first embodiment.

The positive electrode 201 contains a material that can occlude and release metal ions (for example, lithium ions). The material is, for example, the positive-electrode active material 204.

Examples of the positive-electrode active material 204 include a lithium-containing transition metal oxide, a transition metal fluoride, a polyanion, a fluorinated polyanionic material, a transition metal sulfide, a transition metal oxyfluoride, a transition metal oxysulfide, and a transition metal oxynitride. Examples of the lithium-containing transition metal oxide include Li(Ni,Co,Mn)O₂, Li(Ni,Co,Al)O₂, and LiCoO₂.

In the present disclosure, “(A,B,C)” means “at least one selected from the group consisting of A, B, and C”.

The positive-electrode active material 204 may have any shape. The positive-electrode active material 204 may be particles. The positive-electrode active material 204 may have a median size of greater than or equal to 0.1 μm and less than or equal to 100 μm. When the positive-electrode active material 204 has a median size of greater than or equal to 0.1 μm, the positive-electrode active material 204 and the solid electrolyte 100 can be well dispersed in the positive electrode 201. This improves the charge-discharge characteristics of the battery 1000. When the positive-electrode active material 204 has a median size of less than or equal to 100 μm, the lithium diffusion rate in the positive-electrode active material 204 is improved. This allows the battery 1000 to operate at high output power.

The positive-electrode active material 204 may have a larger median size than the solid electrolyte 100. This allows the positive-electrode active material 204 and the solid electrolyte 100 to be well dispersed in the positive electrode 201.

To improve the energy density and output of the battery 1000, in the positive electrode 201, the ratio of the volume of the positive-electrode active material 204 to the sum of the volume of the positive-electrode active material 204 and the volume of the solid electrolyte 100 may be greater than or equal to 0.30 and may be less than or equal to 0.95.

A covering layer may be formed on at least part of the surface of the positive-electrode active material 204. The covering layer may be formed on the surface of the positive-electrode active material 204, for example, before mixing with a conductive additive and a binder. Examples of a covering material contained in the covering layer include a sulfide solid electrolyte, an oxide solid electrolyte, and a halide solid electrolyte. When the solid electrolyte 100 contains a sulfide solid electrolyte, the covering material may contain the solid electrolyte material according to the first embodiment to suppress oxidative decomposition of the sulfide solid electrolyte. When the solid electrolyte 100 contains the solid electrolyte material according to the first embodiment, the covering material may contain an oxide solid electrolyte to suppress oxidative decomposition of the solid electrolyte material. The oxide solid electrolyte may be lithium niobate with high stability at a high electric potential. An increase in overvoltage of the battery 1000 can be reduced by suppressing the oxidative decomposition.

To improve the energy density and output of the battery 1000, the positive electrode 201 may have a thickness of greater than or equal to 10 μm and less than or equal to 500 μm.

The electrolyte layer 202 contains an electrolyte material. The electrolyte material is, for example, a solid electrolyte material. The solid electrolyte material may contain the solid electrolyte material according to the first embodiment. The electrolyte layer 202 may be a solid electrolyte layer.

The electrolyte layer 202 may contain 50% or more by mass of the solid electrolyte material according to the first embodiment. The electrolyte layer 202 may contain 70% or more by mass of the solid electrolyte material according to the first embodiment. The electrolyte layer 202 may contain 90% or more by mass of the solid electrolyte material according to the first embodiment. The electrolyte layer 202 may be composed only of the solid electrolyte material according to the first embodiment.

The solid electrolyte material according to the first embodiment is hereinafter referred to as a first solid electrolyte material. A solid electrolyte material different from the first solid electrolyte material is referred to as a second solid electrolyte material.

The electrolyte layer 202 may contain not only the first solid electrolyte material but also the second solid electrolyte material. In the electrolyte layer 202, the first solid electrolyte material and the second solid electrolyte material may be uniformly dispersed.

The electrolyte layer 202 may composed only of the second solid electrolyte material.

The electrolyte layer 202 may have a thickness of greater than or equal to 1 μm and less than or equal to 1000 μm. When the electrolyte layer 202 has a thickness of 1 μm or more, the positive electrode 201 and the negative electrode 203 are less likely to be short-circuited. When electrolyte layer 202 has a thickness of 1000 μm or less, the battery 1000 can operate at high output power.

Examples of the second solid electrolyte material include LizMgX₄, Li₂FeX₄, Li(Al,Ga,In)X₄, Li₃(Al,Ga,In)X₆, and LiI. X is at least one selected from the group consisting of F, Cl, Br, and I.

To improve the energy density and output of the battery 1000, the electrolyte layer 202 may have a thickness of greater than or equal to 1 μm and less than or equal to 1000 μm.

The negative electrode 203 contains a material that can occlude and release metal ions (for example, lithium ions). The material is, for example, the negative-electrode active material 205.

Examples of the negative-electrode active material 205 include a metallic material, a carbon material, an oxide, a nitride, a tin compound, and a silicon compound. The metallic material may be a single metal or an alloy. Examples of the metallic material include a lithium metal and a lithium alloy. Examples of the carbon material include natural graphite, coke, graphitizing carbon, carbon fiber, spherical carbon, artificial graphite, and amorphous carbon. From the perspective of capacity density, appropriate examples of the negative-electrode active material include silicon (that is, Si), tin (that is, Sn), a silicon compound, and a tin compound.

The negative-electrode active material 205 may be selected in consideration of the reduction resistance of the solid electrolyte material contained in the negative electrode 203. For example, when the negative electrode 203 contains the first solid electrolyte material, the negative-electrode active material 205 may be a material that can occlude and release lithium ions at 0.27 V or more with respect to lithium. Examples of such a negative-electrode active material include titanium oxide, indium metal, and a lithium alloy. Examples of the titanium oxide include Li₄Ti₅O₁₂, LiTi₂O₄, and TiO₂. The negative-electrode active material can be used to suppress the reductive decomposition of the first solid electrolyte material contained in the negative electrode 203. This can improve the charge-discharge efficiency of the battery 1000.

The negative-electrode active material 205 may have any shape. The negative-electrode active material 205 may be particles. The negative-electrode active material 205 may have a median size of greater than or equal to 0.1 μm and less than or equal to 100 μm. When the negative-electrode active material 205 has a median size of greater than or equal to 0.1 μm, the negative-electrode active material 205 and the solid electrolyte 100 can be well dispersed in the negative electrode 203. This improves the charge-discharge characteristics of the battery 1000. When the negative-electrode active material 205 has a median size of less than or equal to 100 μm, the lithium diffusion rate in the negative-electrode active material 205 is improved. This allows the battery 1000 to operate at high output power.

The negative-electrode active material 205 may have a larger median size than the solid electrolyte 100. This allows the negative-electrode active material 205 and the solid electrolyte 100 to be well dispersed in the negative electrode 203.

To improve the energy density and output of the battery 1000, in the negative electrode 203, the ratio of the volume of the negative-electrode active material 205 to the sum of the volume of the negative-electrode active material 205 and the volume of the solid electrolyte 100 may be greater than or equal to 0.30 and may be less than or equal to 0.95.

To improve the energy density and output of the battery 1000, the negative electrode 203 may have a thickness of greater than or equal to 10 μm and less than or equal to 500 μm.

At least one selected from the group consisting of the positive electrode 201, the electrolyte layer 202, and the negative electrode 203 may contain the second solid electrolyte material for the purpose of enhancing ionic conductivity, chemical stability, and electrochemical stability.

The second solid electrolyte material may be a sulfide solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

When the electrolyte layer 202 contains the first solid electrolyte material, the negative electrode 203 may contain a sulfide solid electrolyte to suppress the reductive decomposition of the solid electrolyte material. When an electrochemically stable sulfide solid electrolyte covers the negative-electrode active material, the first solid electrolyte material can be prevented from coming into contact with the negative-electrode active material. This can reduce the internal resistance of the battery 1000.

The second solid electrolyte material may be an oxide solid electrolyte.

The oxide solid electrolyte is, for example,
(i) a NASICON solid electrolyte, such as LiTi₂(PO₄)₃ or an element-substituted product thereof,
(ii) a perovskite solid electrolyte, such as (LaLi)TiO₃,
(iii) a LISICON solid electrolyte, such as Li₁₄ZnGe₄O₁₆, Li₄SiO₄, LiGeO₄, or an element-substituted product thereof,
(iv) a garnet solid electrolyte, such as Li₂La₃Zr₂O₁₂ or an element-substituted product thereof, or
(v) Li₃PO₄ or a N-substitution product thereof.

As described above, the second solid electrolyte material may be a halide solid electrolyte.

Examples of the halide solid electrolyte include Li₂MgX₄, Li₂FeX₄, Li(Al,Ga,In)X₄, Li₃(Al,Ga,In)X₆, and LiI. X is at least one selected from the group consisting of F, Cl, Br, and I.

Another example of the halide solid electrolyte is a compound represented by LiₐMe_{b}Y_{c}X₆. a, b, and c satisfy the relations a+mb+3c=6 and c>0. Me is at least one selected from the group consisting of metal elements and metalloid elements other than Li and Y. X is at least one selected from the group consisting of F, Cl, Br, and I. m is the valence of Me. The “metalloid elements” are B, Si, Ge, As, Sb, and Te. The “metal elements” are all elements included in Groups 1 to 12 of the periodic table (excluding hydrogen) and all elements included in Groups 13 to 16 of the periodic table (excluding B, Si, Ge, As, Sb, Te, C, N, P, O, S, and Se).

To improve the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The halide solid electrolyte may be Li₃YCl₆ or Li₃YBr₆.

The second solid electrolyte material may be an organic polymer solid electrolyte.

Examples of the organic polymer solid electrolyte include a polymer and a lithium salt compound.

The polymer may have an ethylene oxide structure. The polymer having an ethylene oxide structure can contain a large amount of lithium salt and can therefore further increase the ionic conductivity.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from these may be used.

At least one selected from the group consisting of the positive electrode 201, the electrolyte layer 202, and the negative electrode 203 may contain a non-aqueous electrolyte solution, a gel electrolyte, or an ionic liquid to facilitate the transfer of lithium ions and improve the output characteristics of the battery.

The non-aqueous electrolyte solution contains a non-aqueous solvent and a lithium salt dissolved in the non-aqueous solvent.

Examples of the non-aqueous solvent include a cyclic carbonate solvent, a chain carbonate solvent, a cyclic ether solvent, a chain ether solvent, a cyclic ester solvent, a chain ester solvent, and a fluorinated solvent. Examples of the cyclic carbonate solvent include ethylene carbonate, propylene carbonate, and butylene carbonate. Examples of the chain carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the chain ether solvent include 1,2-dimethoxyethane and 1,2-diethoxyethane. Examples of the cyclic ester solvent include γ-butyrolactone. Examples of the chain ester solvent include methyl acetate. Examples of the fluorinated solvent include fluoroethylene carbonate, methyl fluoropropionate, fluorobenzene, fluoroethyl methyl carbonate, and fluorodimethylene carbonate. One non-aqueous solvent selected from these may be used alone. Alternatively, a combination of two or more non-aqueous solvents selected from these may be used.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from these may be used. The concentration of the lithium salt ranges from, for example, 0.5 mol/L or more and 2 mol/L or less

The gel electrolyte may be a polymer material impregnated with a non-aqueous electrolyte solution. Examples of the polymer material include poly(ethylene oxide), polyacrylonitrile, poly(vinylidene difluoride), poly(methyl methacrylate), and a polymer with an ethylene oxide bond.

Examples of the cation contained in the ionic liquid include
(i) an aliphatic chain quaternary salt, such as tetraalkylammonium or tetraalkylphosphonium,
(ii) an alicyclic ammonium, such as pyrrolidinium, morpholinium, imidazolinium, tetrahydropyrimidinium, piperazinium, or piperidinium, and
(iii) a nitrogen-containing heteroaromatic cation, such as pyridinium or imidazolium.

Examples of the anion contained in the ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may contain a lithium salt.

At least one selected from the group consisting of the positive electrode 201, the electrolyte layer 202, and the negative electrode 203 may contain a binder to improve the adhesion between particles.

Examples of the binder include poly(vinylidene difluoride), polytetrafluoroethylene, polyethylene, polypropylene, an aramid resin, polyamide, polyimide, polyamideimide, polyacrylonitrile, poly(acrylic acid), a poly(methyl acrylate) ester, a poly(ethyl acrylate) ester, a poly(hexyl acrylate) ester, poly(methacrylic acid), a poly(methyl methacrylate) ester, a poly(ethyl methacrylate) ester, a poly(hexyl methacrylate) ester, poly(vinyl acetate), polyvinylpyrrolidone, polyether, poly(ether sulfone), hexafluoropolypropylene, a styrene-butadiene rubber, and carboxymethyl cellulose. A copolymer may also be used as a binder. Examples of the binder include a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from these may be used as the binder.

At least one selected from the positive electrode 201 and the negative electrode 203 may contain a conductive additive to improve electronic conductivity.

The conductive additive is, for example,
(i) a graphite, such as natural graphite or artificial graphite,
(ii) carbon black, such as acetylene black or Ketjen black,
(iii) electrically conductive fiber, such as carbon fiber or metal fiber,
(iv) fluorocarbon,
(v) a powder of metal, such as aluminum,
(vi) electrically conductive whisker, such as zinc oxide or potassium titanate,
(vii) an electrically conductive metal oxide, such as titanium oxide, or
(viii) an electrically conductive polymer, such as polyaniline, polypyrrole, or polythiophene.

To reduce the cost, the conductive additive (i) or (ii) may be used.

FIG. 2 is a cross-sectional view of a battery 2000 as a second example of the battery according to the second embodiment. The battery 2000 of the second example has a configuration in which an electrolyte layer 301 is provided instead of the electrolyte layer 202 in the battery 1000 of the first example. The electrolyte layer 301 includes a first solid electrolyte layer 302 and a second solid electrolyte layer 303. The first solid electrolyte layer 302 and the second solid electrolyte layer 303 are stacked in the stacking direction of the battery 2000. The first solid electrolyte layer 302 is disposed between the positive electrode 201 and the second solid electrolyte layer 303. The second solid electrolyte layer 303 is disposed between the first solid electrolyte layer 302 and the negative electrode 203. The battery 2000 may include the positive electrode 201, the first solid electrolyte layer 302, the second solid electrolyte layer 303, and the negative electrode 203 in this order.

A solid electrolyte material contained in the second solid electrolyte layer 303 may have a lower reduction potential than a solid electrolyte material contained in the first solid electrolyte layer 302. Thus, the solid electrolyte material contained in the first solid electrolyte layer 302 can be used without being reduced. This can improve the charge-discharge efficiency of the battery 2000. For example, when the first solid electrolyte layer 302 contains the first solid electrolyte material, the second solid electrolyte layer 303 may contain a sulfide solid electrolyte to suppress the reductive decomposition of the solid electrolyte material. This can improve the charge-discharge efficiency of the battery 2000. The first solid electrolyte layer 302 may contain the first solid electrolyte material. Since the first solid electrolyte material has high oxidation resistance, a battery with good charge-discharge characteristics can be provided.

The battery according to the second embodiment may be a liquid battery. That is, the separator layer may be a separator used in a known liquid battery.

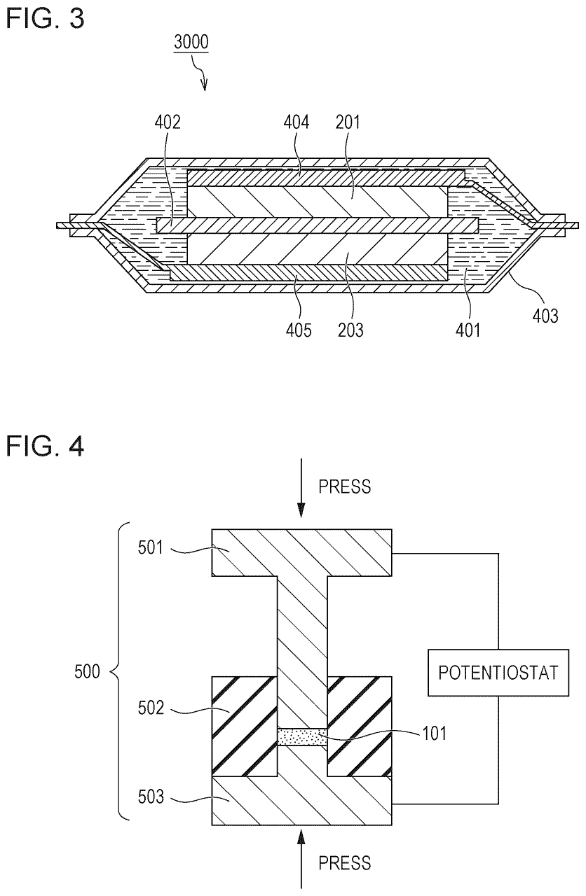

FIG. 3 is a cross-sectional view of a battery 3000 as a third example of the battery according to the second embodiment. The battery 3000 is an example of a liquid battery. In FIG. 3, members having the same functions as those of the members illustrated in FIG. 1 are denoted by the same reference numerals. The battery 3000 includes the positive electrode 201, the negative electrode 203, an electrolyte solution 401, a separator 402, and an outer packaging 403. A current collector 404 is attached to the positive electrode 201. A current collector 405 is attached to the negative electrode 203. The separator 402 is disposed between the positive electrode 201 and the negative electrode 203. The positive electrode 201 faces the negative electrode 203 with the separator 402 interposed therebetween. The positive electrode 201, the negative electrode 203, the separator 402, and the electrolyte solution 401 are housed in the outer packaging 403. The electrolyte solution 401 is, for example, an electrolyte solution with which the positive electrode 201, the negative electrode 203, and the separator 402 are impregnated. As described above, in the battery 3000 having a configuration in which the electrolyte solution is used as an electrolyte, the electrolyte solution 401 impregnated in the separator 402 is positioned between the positive electrode 201 and the negative electrode 203. An internal space of the outer packaging 403 may be filled with the electrolyte solution 401.

In the battery 3000, at least one selected from the group consisting of the positive electrode 201 and the negative electrode 203 contains the solid electrolyte material according to the first embodiment.

Examples of the shape of the battery according to the second embodiment include a coin shape, a cylindrical shape, a square or rectangular shape, a sheet shape, a button shape, a flat shape, and a laminate shape.

### Other Embodiments (Notes)

The following techniques are disclosed by the description of the above embodiments.

### Technique 1

A solid electrolyte material containing Li, Sn, M1, and F, wherein M1 is at least one selected from the group consisting of Al, Y, Zr, Ti, and Mg.

With the above configuration, the solid electrolyte material according to Technique 1 has an improved lithium ion conductivity.

### Technique 2

The solid electrolyte material according to Technique 1, wherein M1 includes at least one selected from the group consisting of Al and Y.

The above configuration can increase the lithium ion conductivity of the solid electrolyte material.

### Technique 3

The solid electrolyte material according to Technique 1, containing Li, Sn, Al, M2, and F, wherein M2 is at least one selected from the group consisting of Y, Zr, Ti, and Mg.

The above configuration can increase the lithium ion conductivity of the solid electrolyte material.

### Technique 4

The solid electrolyte material according to any one of Techniques 1 to 3, wherein a ratio of an amount of substance of Li to a total amount of substance of cation other than Li is greater than or equal to 1.7 and is less than or equal to 4.2.

The above configuration can increase the lithium ion conductivity of the solid electrolyte material.

### Technique 5

The solid electrolyte material according to Technique 2, wherein the solid electrolyte material is represented by the following formula (1-1):

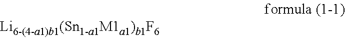

where a1 and b1 satisfy the relations 0<a1<1 and 0<b1≤1.5.

The above configuration can increase the lithium ion conductivity of the solid electrolyte material.

### Technique 6

The solid electrolyte material according to Technique 5, wherein a1 satisfies the relation 0.01≤a1≤0.99.

The above configuration can increase the lithium ion conductivity of the solid electrolyte material.

### Technique 7

The solid electrolyte material according to Technique 5 or 6, wherein a1 satisfies the relation 0.01≤a1≤0.7.

The above configuration can increase the lithium ion conductivity of the solid electrolyte material.

### Technique 8

The solid electrolyte material according to any one of Techniques 5 to 7, wherein M1 is Al, and a1 satisfies the relation 0.01≤a1≤0.99.

The above configuration can increase the lithium ion conductivity of the solid electrolyte material.

### Technique 9

The solid electrolyte material according to any one of Techniques 5 to 8, wherein M1 is Al, and a1 satisfies the relation 0.01≤a1≤0.7.

The above configuration can increase the lithium ion conductivity of the solid electrolyte material.

### Technique 10

The solid electrolyte material according to any one of Techniques 5 to 9, wherein b1 satisfies the relation 0.8≤b1≤1.2.

The above configuration can increase the lithium ion conductivity of the solid electrolyte material.

### Technique 11

The solid electrolyte material according to Technique 3, wherein the solid electrolyte material is represented by the following formula (2-1):

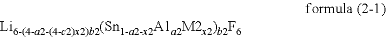

where a2, x2, and b2 satisfy the relations 0<a2<1, 0<x2<1, 0<a2+x2<1, and 0<b2≤1.5; c2 represents a valence of M2.

The above configuration can increase the lithium ion conductivity of the solid electrolyte material.

### Technique 12

The solid electrolyte material according to Technique 11, wherein a2 satisfies the relation 0.01≤a2≤0.99.

The above configuration can increase the lithium ion conductivity of the solid electrolyte material.

### Technique 13

The solid electrolyte material according to Technique 11 or 12, wherein a2 satisfies the relation 0.01≤a2≤0.7.

The above configuration can increase the lithium ion conductivity of the solid electrolyte material.

### Technique 14

The solid electrolyte material according to any one of Techniques 11 to 13, wherein b2 satisfies the relation 0.8≤b2≤1.2.

The above configuration can increase the lithium ion conductivity of the solid electrolyte material.

### Technique 15

A battery including:
a positive electrode;
a negative electrode; and
a separator layer between the positive electrode and the negative electrode,
wherein at least one selected from the group consisting of the positive electrode, the negative electrode, and the separator layer contains the solid electrolyte material according to any one of Techniques 1 to 14.

With the above configuration, the battery according to Technique 15 has good charge-discharge characteristics.

### Technique 16

The battery according to Technique 15, wherein the separator layer is a solid electrolyte layer.

With the above configuration, the battery according to Technique 16 has good charge-discharge characteristics.

### Technique 17

The battery according to Technique 16, wherein
the solid electrolyte layer includes a first solid electrolyte layer and a second solid electrolyte layer,
the first solid electrolyte layer is disposed between the positive electrode and the second solid electrolyte layer,
the second solid electrolyte layer is disposed between the first solid electrolyte layer and the negative electrode, and
the first solid electrolyte layer contains the solid electrolyte material.

With the above configuration, the battery according to Technique 17 has good charge-discharge characteristics.

### EXAMPLES

The present disclosure will be described in more detail below with reference to Examples and Comparative Examples.

### Example 1

### Production of Solid Electrolyte Material

In an argon atmosphere with a dew point of −60° C. or less (hereinafter referred to as a “dry argon atmosphere”), LiF, SnF₄, and AlF₃ were prepared as raw powder materials at a molar ratio of LiF:SnF₄:AlF₃=2.7:0.3:0.7. These raw powder materials were pulverized and mixed in a mortar. The resulting mixed powder was milled in a planetary ball mill at 500 rpm for 12 hours. In this manner, a powder of a solid electrolyte material according to Example 1 was produced. The solid electrolyte material according to Example 1 had a composition represented by Li_{2.7}Sn_{0.3}Al_{0.7}F₆.

### Evaluation of Ionic Conductivity

FIG. 4 is a schematic view of a press forming die 500 used to evaluate the ionic conductivity of the solid electrolyte material.

The press forming die 500 included a punch top 501, a die 502, and a punch bottom 503. The die 502 was formed of insulating polycarbonate. The punch top 501 and the punch bottom 503 were formed of electrically conductive stainless steel.

The press forming die 500 illustrated in FIG. 4 was used to evaluate the ionic conductivity of the solid electrolyte material according to Example 1 by the following method.

In a dry atmosphere with a dew point of −60° C. or less, a powder of the solid electrolyte material according to Example 1 was filled into the press forming die 500. In the press forming die 500, a pressure was applied at 400 MPa to the solid electrolyte material according to Example 1 by using the punch top 501 and the punch bottom 503.

While the pressure was applied, the punch top 501 and the punch bottom 503 were connected to a potentiostat (PrincetonApplied Research, VersaSTAT4) equipped with a frequency response analyzer. The punch top 501 was connected to a working electrode and an electric potential measurement terminal. The punch bottom 503 was connected to a counter electrode and a reference electrode. The impedance of the solid electrolyte material was measured at room temperature by an electrochemical impedance measurement method.

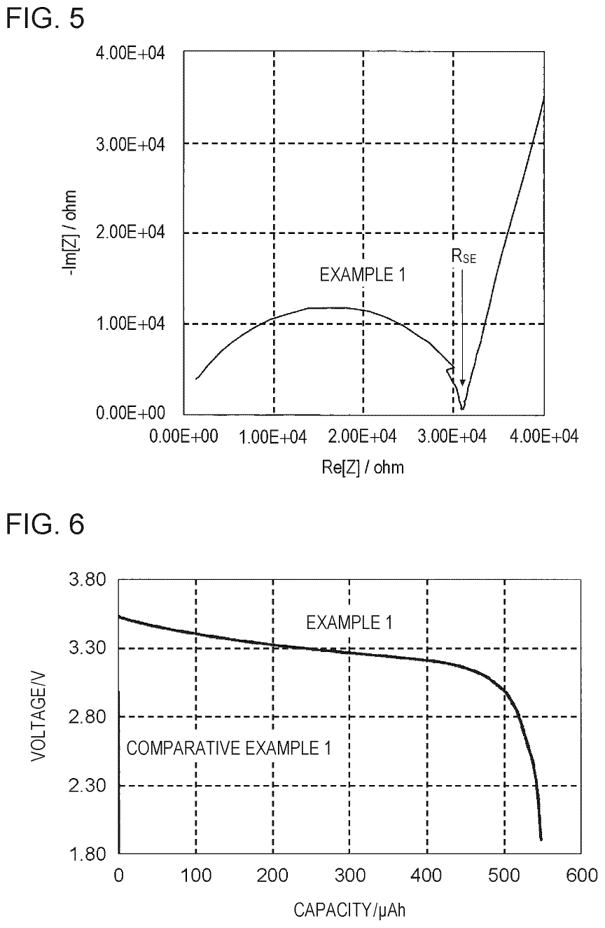

FIG. 5 is a graph of a Cole-Cole plot obtained by the impedance measurement of the solid electrolyte material according to Example 1.

In FIG. 5, the real value of the impedance at a measurement point at which the absolute value of the phase of the complex impedance was smallest was considered to be the resistance to the ionic conduction of the solid electrolyte material. For the real value, see the arrow R_{SE} in FIG. 5. The ionic conductivity was calculated from the resistance using the following mathematical formula (A):

$$σ = {( {R}_{SE} \times S / t )}^{- 1} \qquad ( A )$$

wherein σ denotes the ionic conductivity. S denotes the contact area of the solid electrolyte material with the punch top 501 (equal to the cross-sectional area of the hollow portion of the die 502 in FIG. 4). R_{SE} denotes the resistance of the solid electrolyte material in the impedance measurement. t denotes the thickness of the solid electrolyte material (that is, the thickness of the layer formed of a powder 101 of the solid electrolyte material in FIG. 4).

The ionic conductivity of the solid electrolyte material according to Example 1 measured at 25° C. was 3.89×10⁻⁶ S/cm.

### Production of Battery

In a dry argon atmosphere, the solid electrolyte material according to Example 1 and LiCoO₂ as a positive-electrode active material were prepared at a volume ratio of solid electrolyte material:positive-electrode active material=30:70. These materials were mixed in an agate mortar. In this manner, a positive-electrode mixture was prepared.

Next, LiCl and YCl₃ were prepared at a molar ratio of LiCl:YCl₃=3:1. These materials were pulverized and mixed in a mortar. The resulting mixture was milled in a planetary ball mill at 500 rpm for 12 hours. In this manner, a halide solid electrolyte (hereinafter referred to as “LYC”) having the composition represented by Li₃YCl₆ was prepared.

In an insulating tube with an inner diameter of 9.5 mm, LYC (60 mg), the solid electrolyte material according to Example 1 (26 mg), and the positive-electrode mixture (9.1 mg) were stacked in this order. A pressure was applied at 300 MPa to the resulting laminate to form a second solid electrolyte layer (LYC), a first solid electrolyte layer (the solid electrolyte material according to Example 1), and a positive electrode. Thus, the first solid electrolyte layer formed of the solid electrolyte material according to Example 1 was disposed between the second solid electrolyte layer and the positive electrode. The second solid electrolyte layer and the first solid electrolyte layer had a thickness of 450 μm and 150 μm, respectively.

Next, metal In (thickness: 200 μm) was stacked on the second solid electrolyte layer. A pressure was applied at 80 MPa to the resulting laminate to form a negative electrode.

Next, a current collector formed of stainless steel was attached to the positive electrode and the negative electrode, and a current collector lead was attached to the current collectors.

Finally, an insulating ferrule was used to isolate the inside of the insulating tube from the outside atmosphere and seal the inside of the tube. In this manner, a battery according to Example 1 was produced.

### Charge-Discharge Test

FIG. 6 is a graph of the initial discharge characteristics of the battery according to Example 1. The initial charge-discharge characteristics were measured by the following method.

The battery according to Example 1 was placed in a constant temperature bath at 85° C.

The battery according to Example 1 was charged at a current density of 27 μA/cm² until the voltage reached 3.6 V. This current density corresponds to a rate of 0.02 C.

The battery according to Example 1 was then discharged at a current density of 27 μA/cm² until the voltage reached 1.9 V.

The charge-discharge test showed that the battery according to Example 1 had an initial discharge capacity of 548 μAh.

### Examples 2 to 10

### Production of Solid Electrolyte Material

In Examples 2 to 10, raw powder materials LiF, SnF₄, and AlF₃ were weighed at a molar ratio of LiF:SnF₄:AlF₃=6−(4−a1)b1:(1−a1)b1:a1b1.

“a1”, “b1”, and “Li/(Sn+Al)” in each of Examples 2 to 10 are shown in Table 1 below.

In Examples 2 to 10, solid electrolyte materials were prepared in the same manner as in Example 1.

### Evaluation of Ionic Conductivity

In a glove box maintained in a dry and low-oxygen atmosphere with a dew point of −60° C. or less and an oxygen value of 5 ppm or less, conductivity measurement cells of Examples 2 to 10 were prepared in the same manner as in Example 1.

Except for this, the ionic conductivity was measured in the same manner as in Example 1.

The ionic conductivities in Examples 2 to 10 described above are shown in Table 1 below.

### Production of Battery

In a glove box maintained in a dry and low-oxygen atmosphere with a dew point of −60° C. or less and an oxygen value of 5 ppm or less, each of the solid electrolyte materials according to Examples 2 to 10 and LiCoO₂ as a positive-electrode active material were weighed at a volume ratio of solid electrolyte material:positive-electrode active material=30:70. These were mixed in an agate mortar to prepare positive-electrode mixtures of Examples 2 to 10.

Except for these, batteries according to Examples 2 to 10 were produced in the same manner as in Example 1.

### Charge-Discharge Test

The batteries according to Examples 2 to 10 were subjected to a charge-discharge test in the same manner as in Example 1. The initial discharge characteristics of Examples 2 to 10 were the same as those of Example 1, and good charge-discharge characteristics were achieved.

### Comparative Example 1

LiBF₄ was used as a solid electrolyte material, and evaluation and analysis were performed in the same manner as in Example 1.

The ionic conductivity measured at 25° C. was 6.67×10⁻⁹ S/cm.

The solid electrolyte material of Comparative Example 1 was used as a solid electrolyte material used for the positive-electrode mixture and the solid electrolyte layer.

Except for this, the production of a battery and the charge-discharge test were performed in the same manner as in Example 1.

The initial discharge capacity of the battery of Comparative Example 1 was 0.01 μAh or less, and the charge-discharge operation could not be observed.

Table 1 shows the configurations and evaluation results in Examples 1 to 10 and Comparative Example 1 described above.

TABLE 1

| | | | | Li/(Sn + | Ionic |
|---|---|---|---|---|---|
| | Compositional | | | Al) molar | conductivity |
| | formula | a1 | b1 | ratio | [S/cm] |
| Example 1 | Li_{2.7}Sn_{0.3}Al_{0.7}F₆ | 0.3 | 1 | 2.70 | 3.89 × 10⁻⁶ |
| Example 2 | Li_{2.99}Sn_{0.01}Al_{0.99}F₆ | 0.01 | 1 | 2.99 | 5.52 × 10⁻⁷ |
| Example 3 | Li_{2.9}Sn_{0.1}Al_{0.9}F₆ | 0.1 | 1 | 2.90 | 2.29 × 10⁻⁶ |
| Example 4 | Li_{2.5}Sn_{0.5}Al_{0.5}F₆ | 0.5 | 1 | 2.50 | 1.91 × 10⁻⁶ |
| Example 5 | Li_{2.3}Sn_{0.7}Al_{0.3}F₆ | 0.7 | 1 | 2.30 | 5.23 × 10⁻⁷ |
| Example 6 | Li_{2.19}Sn_{0.99}Al_{0.01}F₆ | 0.99 | 1 | 2.01 | 8.36 × 10⁻⁹ |
| Example 7 | Li_{2.37}Sn_{0.33}Al_{0.77}F₆ | 0.3 | 1.1 | 2.15 | 2.26 × 10⁻⁶ |
| Example 8 | Li_{2.04}Sn_{0.36}Al_{0.84}F₆ | 0.3 | 1.2 | 1.70 | 1.13 × 10⁻⁶ |
| Example 9 | Li_{3.03}Sn_{0.27}Al_{0.63}F₆ | 0.3 | 0.9 | 3.37 | 1.99 × 10⁻⁶ |
| Example 10 | Li_{3.36}Sn_{0.24}Al_{0.56}F₆ | 0.3 | 0.8 | 4.20 | 4.69 × 10⁻⁶ |
| Comparative | LiBF₄ | — | — | — | 6.67 × 10⁻⁹ |
| example 1 | | | | | |

### DISCUSSION

The solid electrolyte materials according to Examples 1 to 10 had a high ionic conductivity of 8×10⁻⁹ S/cm or more at room temperature (25° C.).

The batteries according to Examples 1 to 10 were all charged and discharged at 85° C. By contrast, the battery according to Comparative Example 1 was neither charged nor discharged.

Since Ti and Zr have the same valence of 4 as Sn, Y has the same valence of 3 as Al, and Mg has an ionic radius close to that of Sn, it is thought that even when M1 is an element other than Al, that is, Y, Zr, Ti, or Mg, an improved lithium ion conductivity can be achieved as in the case of the solid electrolyte materials according to Examples 1 to 10.

The solid electrolyte materials according to Examples 1 to 10 do not contain sulfur and therefore do not generate hydrogen sulfide.

As described above, the solid electrolyte material according to the present disclosure has a higher lithium ion conductivity than LiBF₄, which is a known fluoride solid electrolyte material, and is suitable for providing a battery that can be satisfactorily charged and discharged.

The solid electrolyte material according to the present disclosure is used, for example, in an all-solid-state lithium-ion secondary battery.

What is claimed is:

1. A solid electrolyte material containing Li, Sn, M1, and F, wherein M1 is at least one selected from the group consisting of Al, Y, Zr, Ti, and Mg.

2. The solid electrolyte material according to claim 1, wherein M1 includes at least one selected from the group consisting of Al and Y.

3. The solid electrolyte material according to claim 1, comprising Li, Sn, Al, M2, and F, wherein M2 is at least one selected from the group consisting of Y, Zr, Ti, and Mg.

4. The solid electrolyte material according to claim 1, wherein a ratio of an amount of substance of Li to a total amount of substance of cation other than Li is greater than or equal to 1.7 and is less than or equal to 4.2.

5. The solid electrolyte material according to claim 2, wherein the solid electrolyte material is represented by the following formula (1-1): 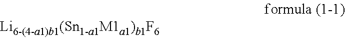
where a1 and b1 satisfy the relations 0<a1<1 and 0<b1≤1.5.

6. The solid electrolyte material according to claim 5, wherein a1 satisfies the relation 0.01≤a1≤0.99.

7. The solid electrolyte material according to claim 5, wherein a1 satisfies the relation 0.01≤a1≤0.7.

8. The solid electrolyte material according to claim 5, wherein M1 is Al, and a1 satisfies the relation 0.01≤a1≤0.99.

9. The solid electrolyte material according to claim 5, wherein M1 is Al, and a1 satisfies the relation 0.01≤a1≤0.7.

10. The solid electrolyte material according to claim 5, wherein b1 satisfies the relation 0.8≤b1≤1.2.

11. The solid electrolyte material according to claim 3, wherein the solid electrolyte material is represented by the following formula (2-1): 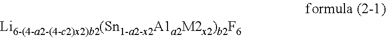
where a2, x2, and b2 satisfy the relations 0<a2<1, 0<x2<1, 0<a2+x2<1, and 0<b2≤1.5; c2 represents a valence of M2.

12. The solid electrolyte material according to claim 11, wherein a2 satisfies the relation 0.01≤a2≤0.99.

13. The solid electrolyte material according to claim 11, wherein a2 satisfies the relation 0.01≤a2≤0.7.

14. The solid electrolyte material according to claim 11, wherein b2 satisfies the relation 0.8≤b2≤1.2.

15. A battery comprising:
a positive electrode;
a negative electrode; and
a separator layer between the positive electrode and the negative electrode,
wherein at least one selected from the group consisting of the positive electrode, the negative electrode, and the separator layer contains the solid electrolyte material according to claim 1.

16. The battery according to claim 15, wherein the separator layer is a solid electrolyte layer.

17. The battery according to claim 16, wherein
the solid electrolyte layer includes a first solid electrolyte layer and a second solid electrolyte layer,
the first solid electrolyte layer is disposed between the positive electrode and the second solid electrolyte layer,
the second solid electrolyte layer is disposed between the first solid electrolyte layer and the negative electrode, and
the first solid electrolyte layer contains the solid electrolyte material.
